(19) United States
(12) Patent Application Publication
(10) Pub. No.: US 2007/0023599 A1
(43) Pub. Date: Feb. 1, 2007

(54) Adjustable display mount apparatus and system

(76) Inventor: Dale Fedewa, Phoenix, AZ (US)

Correspondence Address: KUNZLER & ASSOCIATES, 8 EAST BROADWAY, SUITE 600, SALT LAKE CITY, UT, 84111, US

(21) Appl. No.: 11/244,951

(22) Filed: Oct. 5, 2005

Related U.S. Application Data
(63) Continuation-in-part of application No. 11/189,513, filed on Jul. 26, 2005.

(51) Int. Cl. E04G 3/00; G09G 5/00

(52) U.S. Cl. 248/284.1; 248/289.11; 248/923; 345/156

(57) ABSTRACT

An embodiment of an adjustable display mount apparatus and system comprises a mounting bracket for attachment to a mounting surface, a display attachment apparatus for attachment to the display, a first arm attached at one end to the mounting bracket and at the other end to the display attachment apparatus, and a second arm attached at one end to the mounting bracket in sliding engagement and at the other end to the display attachment apparatus. The arms cross each other at a pivotal cross point, enabling the arms to move relative to each other and the mounting surface, thus moving the display toward or away from the mounting surface. The first arm may articulate to enable tilting of the display.

### PRIORITY APPLICATIONS

This application is a continuation-in-part of co-pending patent application Ser. No. 11/189,513, filed on Jul. 26, 2005, for “Flat Panel Display Mounting Apparatus and System.”

### BACKGROUND OF THE INVENTION

1. Field of the Invention

This invention relates to mounting systems, and more particularly to a flat-panel display mounting apparatus which enables the display to be attached to a mounting surface and positioned at an optimum viewing location and angle.

2. Description of the Related Art

The popularity of electronic flat-panel displays, such as for televisions and computers, has greatly increased in recent years as such displays have become increasingly available and inexpensive. Currently manufactured and marketed displays come in a variety of different sizes and types, including liquid-crystal, light-emitting-diode, and plasma screens. Given that these types of displays are thinner than traditional cathode-ray or projection screens, these displays may be positioned or mounted in a large variety of ways and places—particularly, as is becoming increasingly popular, on a wall or similar mounting surface.

Ways of mounting such displays range from using simple devices that hang the display on the wall like a picture to large mounting systems that enable close to universal position adjustment or other features. Some of these latter systems are cantilevered away from the wall, such that the position of the display can be adjusted, while others comprise adjustable protrusions of various sorts to provide for limited position and orientation adjustment—most commonly, the angle at which the display is tilted, tilting comprising rotating the display around a horizontal axis. Others allow for panning (similar to tilting, except that the display is rotated around a vertical axis). Other types of adjustment include translational depth (the distance the display is located from the wall), translational vertical positioning, and translational horizontal positioning.

Even given their complexity, many existing systems are limited in their capabilities. Current mounting systems can be and often are expensive, heavy, and awkwardly large, limiting the surfaces on which a flat-panel display can be mounted.

The complex nature of many mounting systems also detracts from the sleek aesthetic appeal of the flat-panel display, which is one of the primary reasons consumers purchase such displays in the first place.

Many mounting systems are further limited in that they are unable to accommodate more than one or a few of the large variety of screens offered by different manufacturers—and often the same manufacturer—which can vary in weight, height, depth, breadth, delicacy, and method of mounting.

Generally, the more numerous the ways of adjusting position and orientation in mounting systems, the larger, more expensive, and more complex the mounting system becomes. Some existing mounting systems take up 1,500 cubic inches of space, limiting the locations in which they may be placed.

A desirable feature for a mounting system is continuous, catchless, adjustment, i.e., a system that can be adjusted smoothly within a range of positions and that stays in a desired position without the need for detents or stops holding it in place.

From the foregoing discussion, it should be apparent that a need exists for an apparatus and system that allows for adjustment of the flat-panel display in as optimal a viewing position as possible, using as many different types of adjustment as possible, while minimizing disadvantages such as high cost, weight, and bulkiness. Beneficially, such an apparatus, system, and method would accommodate a large number of displays of differing manufacture and size and be configured at least partially for smooth adjustment.

### SUMMARY OF THE INVENTION

The present invention has been developed in response to the present state of the art, and in response to the problems and needs in the art that have not yet been fully solved by currently available display mounting apparatuses and systems. In particular, the invention addresses the adjustment capabilities of display mounting systems while minimizing problems of cost, complexity, and size.

In accordance with one aspect of the invention, an embodiment of a display mounting apparatus includes a first arm having a proximal end and a distal end, with the proximal end operatively attaching to a mounting surface, such as by a mounting bracket, and the distal end operatively attaching to the display, such as by a display attachment apparatus. The apparatus further includes a second arm having a proximal end and a distal end with the proximal end operatively attaching to the mounting surface and the distal end operatively attaching to the display. The first arm and the second arm are disposed in approximately the same vertical plane, and cross each other at a crossing point. The crossing point is disposed between the proximal end and the distal end of the first arm and between the proximal end and the distal end of the second arm.

In one embodiment, the first arm and the second arm are movably attached at the crossing point. The proximal end of the second arm, disposed below the proximal end of the first arm, is configured to attach at any of a plurality of points on the mounting bracket, in sliding engagement in one embodiment, whereby the display can move toward away from the mounting surface by moving the first and second arms relative to each other, thus moving the distal ends of the first and second arms toward or away from the mounting surface.

In a further embodiment, the first arm is configured to articulate at an articulation site located between the distal end of the first arm and the crossing point. Thus the first arm comprises a major segment between the proximal end and the articulation point and a minor segment between the articulation point and the distal end. A positioning apparatus may be supplied to hold the major and minor segments in fixed relation to each other at any of a plurality of angles.

In a further embodiment, an X bracket is used in place of the first and second arms, the X bracket having two arms and four ends, the first and second ends attaching to the mounting bracket, the third end attaching to the display bracket, and the fourth end abutting the display bracket. The arms of the X bracket can be movable relative to each other. In one embodiment, the fourth end moves independently from the first, second, and third ends to enable tilting of the display.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that they depict only typical embodiments of the invention and are not therefore to be considered to be limiting of its scope, the invention will be described and explained with additional specificity and detail through the use of the drawings, in which:

FIG. 1A is a schematic side elevational view of an embodiment of an adjustable display mount according to an aspect of the present invention, with the display disposed away from the wall and tilted down;

FIG. 1B is a schematic side elevational view of the adjustable display mount of FIG. 1, with the display disposed nearer the wall and tilted up;

FIG. 2 is a schematic plan view of an embodiment of an adjustable display mounting system according to an aspect of the present invention, with the display panned;

FIG. 3A is a perspective view of an embodiment of a display attachment apparatus according to an aspect of the present invention, with the display disposed in a first horizontal position;

FIG. 3B is a perspective view of the display attachment apparatus of FIG. 3A, with the display disposed in a second horizontal position;

FIG. 4 is a perspective view of an embodiment of a horizontal cross member used in the display attachment apparatus of FIG. 3A;

FIG. 5 is a front elevational view of an embodiment of a vertical attachment member used in the display attachment apparatus of FIG. 3A, including a vertical extension member;

FIG. 6A is a side elevational view of the vertical attachment member of FIG. 5, attached to a display in a first vertical position;

FIG. 6B is a side elevational view of the vertical attachment member of FIG. 5, attached to the display in a second vertical position;

FIG. 7A is a perspective view of an embodiment of an adjustable display mount according to an aspect of the present invention, with the mount disposed in a first position;

FIG. 7B is a perspective view of the adjustable display mount of FIG. 7A, with the mount disposed in a second position;

FIG. 8 is a perspective view of an embodiment of a mounting bracket used in the adjustable display mount of FIG. 7A;

FIG. 9 is a perspective view of an embodiment of an arm member used in the adjustable display mount of FIG. 7A;

FIG. 10 is a perspective view of an embodiment of a major arm segment used in the adjustable display mount of FIG. 7A;

FIG. 11 is a perspective view of an embodiment of a minor arm segment used in the adjustable display mount of FIG. 7A; and

FIG. 12 is a perspective view of an embodiment of a tilt bracket used in the adjustable display mount of FIG. 7A.

### DETAILED DESCRIPTION OF THE INVENTION

It will be understood that the components of the present invention, as generally described and illustrated in the figures herein, may be arranged and designed in a wide variety of different configurations. Thus, the following, more detailed, description of the embodiments of the apparatus, system, and method of the present invention is not intended to limit the scope of the invention as claimed, but is merely representative of selected embodiments.

The illustrated embodiments of the invention will be best understood by reference to the drawings, wherein like parts are designated by like numerals throughout. Those of ordinary skill in the art will appreciate that various modifications to the devices, systems, and processes may readily be made without departing from the essential characteristics of the invention. Thus, the following description is intended only by way of example, illustrating certain selected embodiments of devices, systems, and processes that are consistent with the invention as claimed herein.

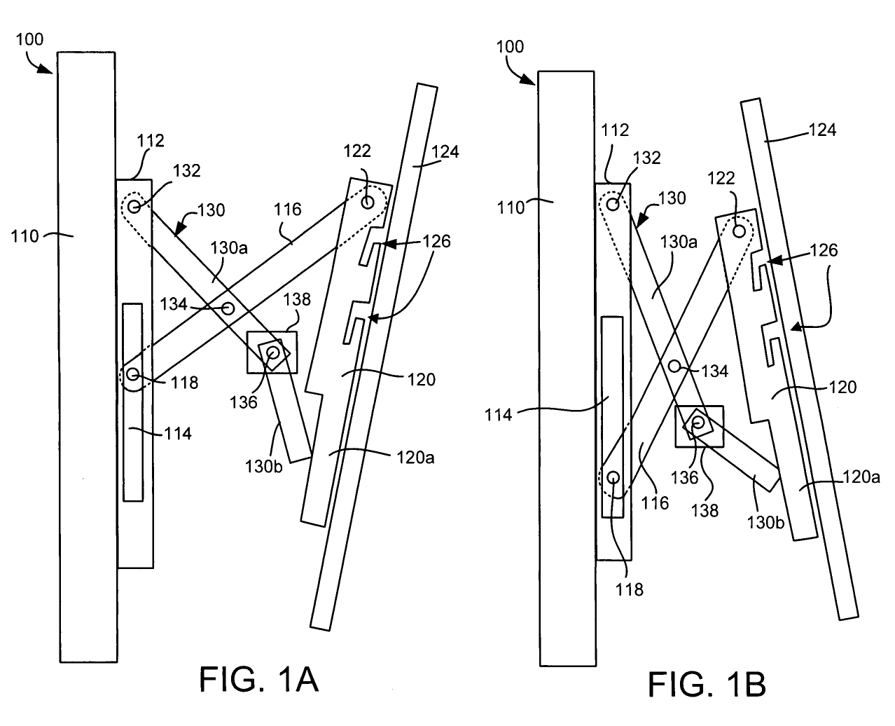

Referring to FIG. 1A, an embodiment of a flat-panel display mounting apparatus 100 according to the present invention is shown in schematic form. The mounting apparatus 100 attaches to a wall 110 or other mounting surface, and to a flat-panel display 124 or other display. The mounting apparatus 100 comprises an elongate mounting bracket 112 attaching to the wall 110 by any suitable attachment method, such as bolts. An elongate slot 114 is disposed in the lower portion of the mounting bracket 112. A sliding arm 106 is attached at one end to the mounting bracket 112 via a bolt or rod 118 configured to slide up and down the slot 114 and keep the sliding arm 116 in sliding engagement with the mounting bracket 112.

The sliding arm 116 pivotally attaches at its opposite end to an elongate tilt bracket 120 via a bolt 122. The tilt bracket 120 contains hooks 126 for attachment to a display or display attachment apparatus, embodiments of which are described below, and a lower portion 120a. The display 124 operatively attaches to the tilt bracket, as further described below and as described in parent application Ser. No. 11/189,513, filed on Jul. 26, 2005, for “Flat Panel Display Mounting Apparatus and System,” incorporated herein by reference.

One end of a tilt arm 130 pivotally attaches to the upper portion of the mounting bracket 110 via a bolt 132. The tilt arm 130 comprises two segments: a major segment 130a, attached to the mounting bracket 110, and a minor segment 130b. The major and minor segments 130a and 130b attach at an articulation site 136, and are configured to articulate relative to each other, such that they can be positioned at any of a plurality of angles relative to each other. A positioning mechanism 138 is provided to maintain the major and minor segments 130a and 130b in any particular desired orientation. The end of the minor segment 130b opposite the articulation site 136 abuts the lower portion 120a of the tilt bracket 120, and is configured to slide relative thereto.

The positioning mechanism 138 may comprise a ratchet mechanism or other arrangement suitable for fixing the position of the major and minor segments 130a and 103b relative to each other.

The major segment 130a of the tilt arm 130 pivotally attaches to the sliding arm 116 at a crossing point 134 via a bolt or other means, putting the arms 116 and 130 basically in the shape of an X. The configuration may be viewed as an X bracket in some embodiments.

The pivotal attachment of the arms 116 and 130 and the sliding engagement of the sliding arm 116 with the mounting bracket 112 allow for translational movement of the tilt bracket 120, and thus the display 124, toward and away from the wall 110, the movement being limited, in one embodiment, by the length of the slot 114. Other embodiments may limit the movement by naturally occurring methods, i.e., the limitations of the apparatus parts in abutting the wall 110 and each other.

In FIG. 1A, the pivoting of the arms 116 and 130 at the crossing point 134 have taken the tilt bracket 120 and display 124 away from the wall. Since the bolt 118 is near the top of the slot 114 the tilt bracket 120 and display 124 may be moved farther away from the wall 110, but not by much.

FIG. 1B shows the mounting apparatus 100 in a position wherein the tilt bracket 120 and display 124 have been moved closer to the wall 110 than shown in FIG. 1A by pivotal movement of the arms 116 and 130 at the crossing point 134. In this position, the bolt 118 is near the bottom of the slot 114, meaning the display 124 may be moved closer to the wall 110, but not by much.

In one embodiment, the arrangement of the mounting apparatus 100 components allows for continuous translational adjustment of the display 124, and dispenses with the need for detents or other mechanisms to hold the display 124 in a particular translational position.

FIG. 1A illustrates downward tilting of the display 124 through articulation of the major and minor segments 130a and 130b of the tilt arm 130. As shown, the minor segment 130a has been moved angularly downward, with the segments 130a and 130b being fixed in that position by the positioning mechanism 138. The angular downward movement of the minor segment 130a results in the end of the minor segment 130a abutting the tilt bracket 120 moving toward the wall 110. Due to the relative positions of the display 124 and the pivotal attachment bolt 122, the weight of the display 124 urges the tilt bracket 120 back against the minor segment 130b, resulting in downward tilting of the display 124.

As shown in FIG. 1B, the minor segment 130 can also be moved angularly upward, fixed in position by the positioning mechanism 138, resulting in the end of the minor segment 130a abutting the tilt bracket 120 to move away from the wall 110, tilting the tilt bracket 120 and display 124 upward.

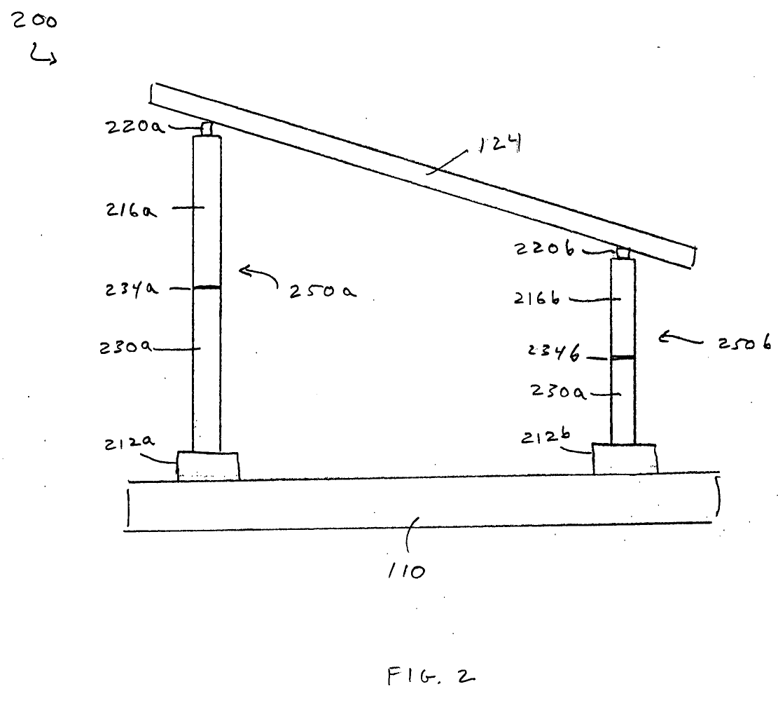

Referring now to FIG. 2, an embodiment of a display mounting apparatus 200 according to the present invention is shown schematically in plan view. The apparatus 200 uses two mounting assemblies 250a and 250b to allow for rotational panning of the display 124. Each mounting assembly 250a and 250b can be similar or identical in construction to the apparatus 100, with mounting brackets 212a,b attached to the wall 110, tilting arms 230a,b, sliding arms 216a,b, and tilt brackets 220a,b. To pan the display 124, the mounting assembly 250a is positioned farther away from the wall 110, such as is shown in FIG. 1A, and the mounting assembly 250b is positioned closer to the wall 110, such as is shown in FIG. 1B (discounting, for illustrative purposes, the tilting of the display 124 shown in FIGS. 1A and 1B). As will be appreciated, given the continuous nature of translational movement of the apparatus 100, the display 124 can be panned in a wide range of panning positions, again, in one embodiment, without the need for detents or arresting mechanisms.

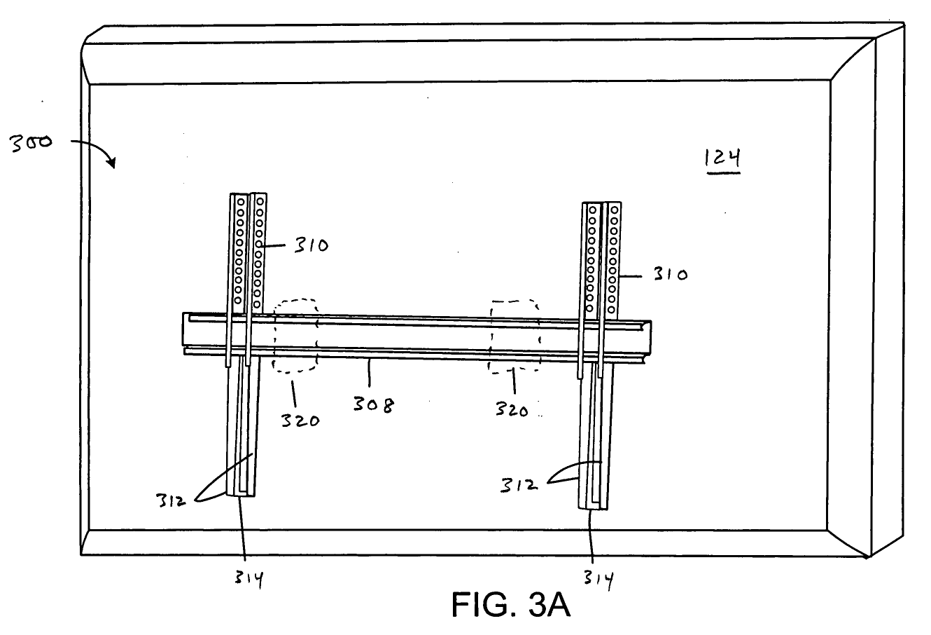

Referring now to FIG. 3A, one embodiment of a display attachment apparatus 300 according to the invention is shown. The display attachment apparatus 300 attaches to tilt brackets 320, shown schematically in phantom, and to the display 124.

In the illustrated embodiment, a horizontal cross member 308 attaches to the tilt brackets 320 in sliding engagement. This method of attachment allows for translational horizontal adjustment of the display by moving the tilt brackets 320 into different positions on the cross member 308. FIG. 3B shows different horizontal positioning of the display 124 due to different placement of the tilt brackets 320 on the cross member 308.

Two vertical attachment members 310 attach to the cross member 308, also in sliding engagement, with the display 124 attached to the vertical attachment members 310. Each vertical attachment member 310 is elongated and constructed with a center portion 314 and flanges 312 extending from the edges of the center portion 314, the flanges 312 strengthening the vertical attachment members 310 and accommodating placement of the horizontal cross member 308. The vertical attachment members 310 allow for vertical adjustment of the display 124, as further described below.

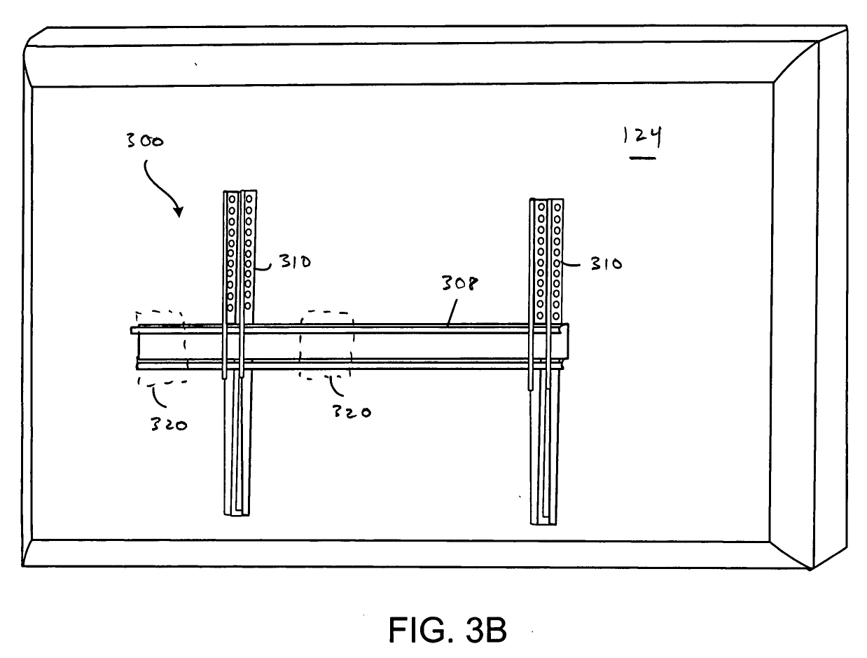

Referring now to FIG. 4, the horizontal cross member 308 is elongated and shaped in cross-section such that it attaches to the tilt brackets 320 in secure engagement. The cross member 308 comprises a center portion 410, an upper edge portion 412 extending from the upper part of the center portion 410, and an upper flange 414 extending downwardly from the upper edge portion 412. A lower edge portion 416 extends from the lower part of the center portion 410, and a lower flange 418 extends downwardly from the lower edge portion 416.

When engaging tilt brackets 320 that are constructed similarly to the tilt bracket 120 shown in FIGS. 1A and 1B, the upper flange 414 and the upper edge portion 412 engage with the upper hook 126 of the tilt bracket 414, and the lower flange 418 and the lower edge portion 416 engage with the lower hook 126 of the tilt bracket 414.

In one embodiment, the weight of the display 124 urges the cross member 308 into secure engagement with the hooks 126. When the weight of the display 124 is partially or wholly relieved, such as when the user lifts the display 124, the user is able to slide the cross member 308 through the tilt brackets 320, moving the display 124 in a horizontal direction for desired positioning.

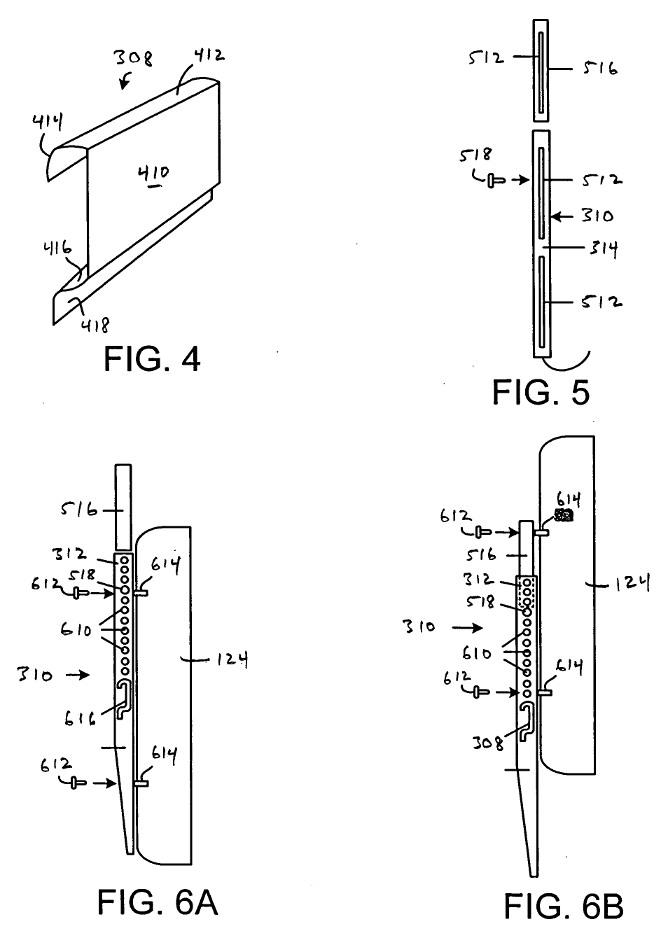

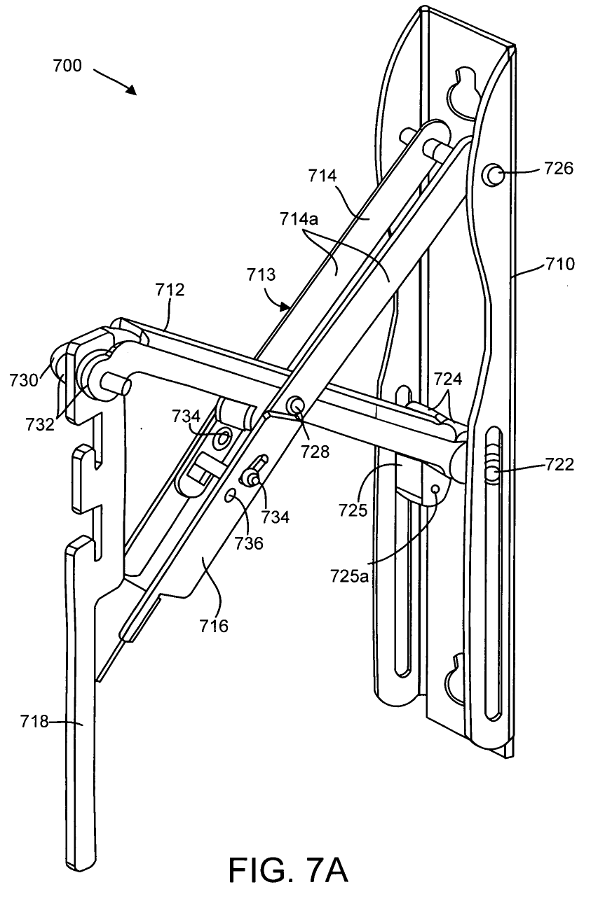

Referring now to FIGS. 5 and 6A, each vertical attachment member 310 contains upper and lower slots 512 to accommodate screws 612 or other attachment devices, which attach to the flat-panel display 124 by threaded mounting holes 614.

Each vertical attachment member 310 contains an opening 616 for accommodation of the horizontal cross member 308 therein in sliding engagement. The opening 616 is preferably approximately the same size and shape as the cross member 308 in cross-section, to allow for snug sliding engagement between the cross member 308 and the vertical attachment members 310. The vertical attachment members 310 can be moved independently of each other along the horizontal cross member 308. Similarly to the engagement of the tilt brackets 320 to the cross member 308, when the weight of the display 124 is allowed to rest entirely on the display attachment apparatus 300, the weight causes the cross member 308 to press against the opening 616, frictionally securing the engagement between the cross member 308 and vertical attachment members 310 by making it difficult or impossible to slide the cross member 308 through the opening 616. When the display attachment apparatus 300 is partially or wholly relieved of the weight of the display 124, such as when the user lifts the display 124, the user is more easily able to slide the cross member 308 through the opening 616 for horizontal adjustment of the display 124.

The vertical attachment members 310 can be attached to a wide variety of flat-panel displays 124, each display having its own particular placement of the mounting holes 614. This is due to the slots 512 accommodating the screws 612 in numerous positions along the length of the slots 512, which allows the display attachment apparatus 300 to adapt to a wide variety of vertical placement of mounting holes 614. In addition, one or both of the vertical attachment members 310 can be moved horizontally along the cross member 308, as needed, for the slots 512 to meet with the mounting holes 614, thus accommodating differences in horizontal placement of the mounting holes 614.

In addition to accommodating different positions of the mounting holes 614, the display 124 can be moved translationally up or down by positioning the screws 612 at different points along the slots 516. The display 124 can also be moved horizontally by positioning the vertical attachment members 310 at different points along the cross member 308, as well as positioning the tilt brackets 320 at different points along the cross member 308, as shown in FIG. 3B.

Referring now to FIGS. 6A and 6B, the vertical attachment members 310 further contain a plurality of paired holes 610 in the flanges 312. Flat-panel displays currently have screens with sizes up to approximately 84 inches. Should the mounting holes 614 be spaced at a distance that is longer than a vertical attachment member 310 can accommodate, a vertical extension member 516, of similar construction to the vertical attachment members 310 (albeit somewhat narrower such that it can fit within the vertical attachment member 310) can be employed. The vertical extension member 516 also allows for additional vertical adjustment of the display 124.

In one embodiment, the vertical extension member 516 can be inserted into the vertical attachment member 310, allowing gravity to pull it through until the extension member 516 abuts a bolt 518 disposed through a selected hole pair 610. Each vertical extension member 516 contains a slot 512, similar to the slots 512 in the vertical attachment members 310, for placement of the screws 612 into the mounting holes 614 of the flat-panel display 124.

FIG. 6A shows the vertical extension member 516 before it is inserted into the vertical attachment member 310. FIG. 6B shows the vertical extension member 516 after it is inserted into the vertical attachment member 310. FIG. 6B also shows the display 124 vertically repositioned from its position in FIG. 5, moved up such that the top screw 612 is inserted into the mounting hole 614 through the slot 512 in the vertical extension member 516.

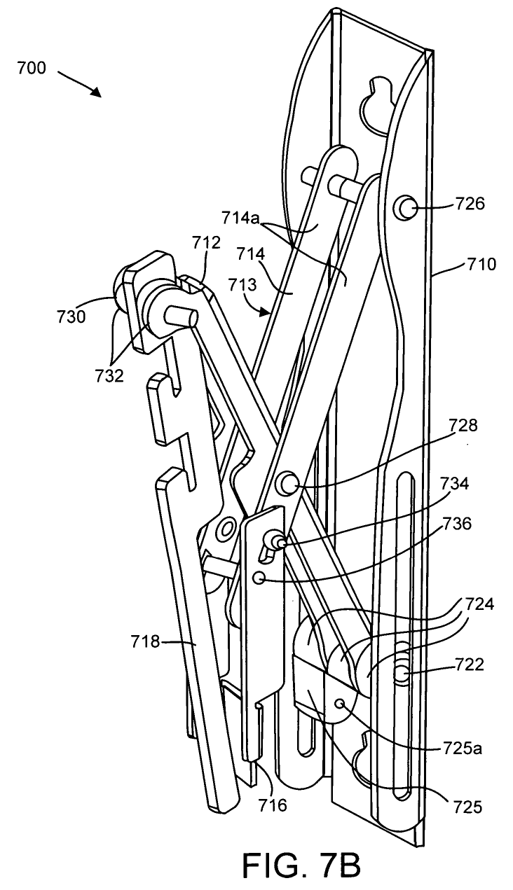

Referring now to FIGS. 7A and 7B, an embodiment of an adjustable display mounting apparatus 700 according to the present invention is shown. The apparatus 700 may constitute a particular embodiment of the mounting apparatus 100 shown in FIGS. 1A and 1B, and may be used in similar fashion to the apparatus 100 for panning the display 124 (FIG. 2) and other adjustments.

The apparatus 700 comprises, in brief, an elongate mounting bracket 710, a sliding arm 712, and a tilt arm 713, the tilt arm 713 comprising a major segment 714 and a minor segment 716. The major and minor segments 714 and 716 could alternatively be separate arms rather than segments of a single arm. The major segment 714 of the tilt arm 713 comprises sub-segments 714a. The apparatus further comprises a tilt bracket 718. Each of these components will be described in further detail with reference to other figures.

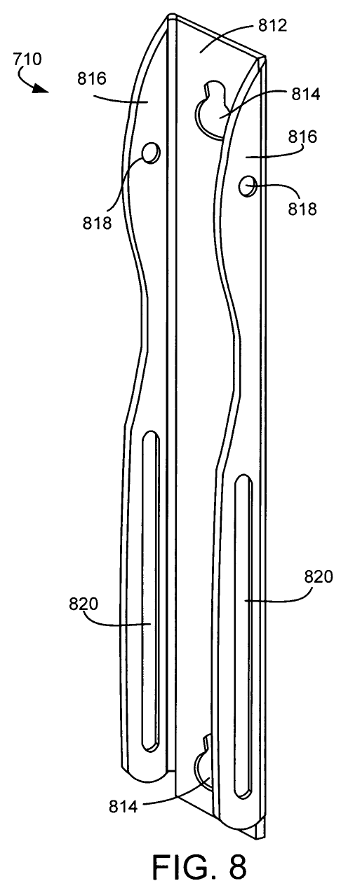

Referring to FIG. 8, which shows details of the mounting bracket 710, the mounting bracket 710 comprises a center portion 812 with holes 814 suitable for accommodating mounting bolts for attachment to the mounting surface. Flanges 816 extend lengthwise from the sides of the center portion 812, the flanges 816 containing holes 818 for attachment of the tilt arm 713. Elongate slots 820 are disposed in the flanges 816 for attachment of the sliding arm 712.

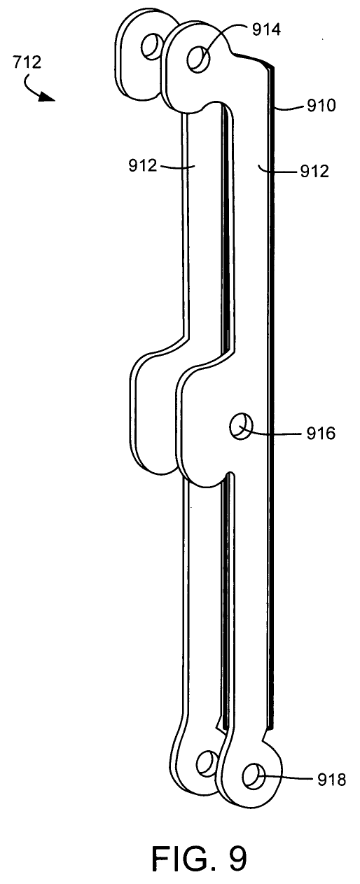

Referring to FIG. 9, which shows details of the elongate sliding arm 712, the sliding arm 712 comprises a center portion 910 and flanges 912 extending lengthwise from the edges of the center portion 910. Holes 914 are disposed at one end of the flanges 912 for attachment to the tilt bracket 718, holes 916 are disposed approximately at the midpoint of the flanges 912 for attachment to the tilt arm 713, and holes 918 are disposed at the opposite end of the flanges 912 for attachment to the mounting bracket 710.

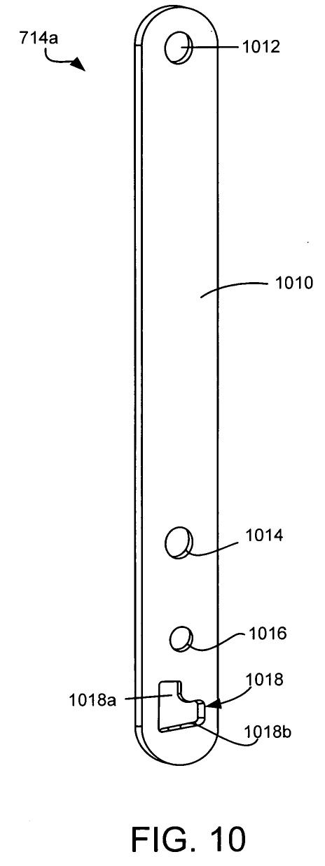

FIG. 10 shows details of a sub-segment 714a of the major segment 714 of the tilt arm 713. The sub-segment 714a comprises a relatively flat, elongated body 1010, a hole 1012 disposed at one end of the body 1010 for attachment to the mounting bracket 710, a hole 1014 approaching the opposite end of the body 1010 for attachment of the sliding arm 712, a hole 1016 near the opposite end of the body 1010 for engagement with the minor segment 716, and an angled slot 1018, substantially in the shape of an L, for engagement with the minor segment 716. The angled slot 1018 contains an upper portion 1018a and a rearward portion 1018b.

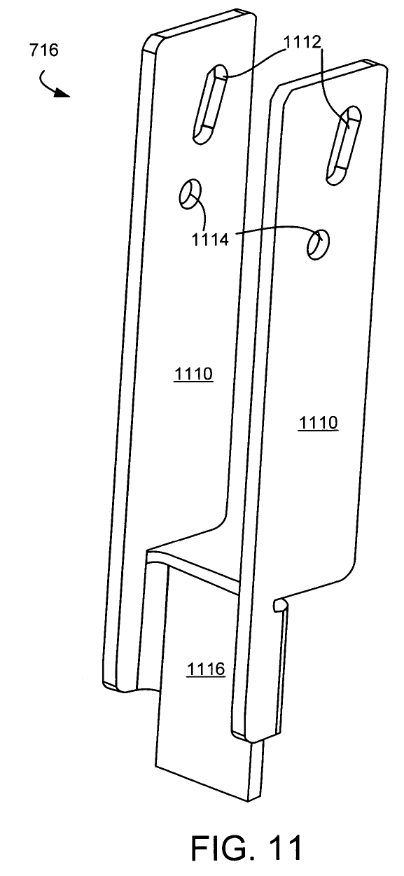

FIG. 11 shows details of the minor segment 716 of the tilt arm 713. The minor segment 716 comprises a relatively flat central lower portion 1116, and two flat side portions 1110 extending upward and perpendicularly from the sides of the lower portion 1116. Slots 1112 are disposed at one end of the side portions 1110 for engagement with the major segment 713, and holes 1114 are disposed near the midpoint of the side portions 1110 for engagement with the major segment 713.

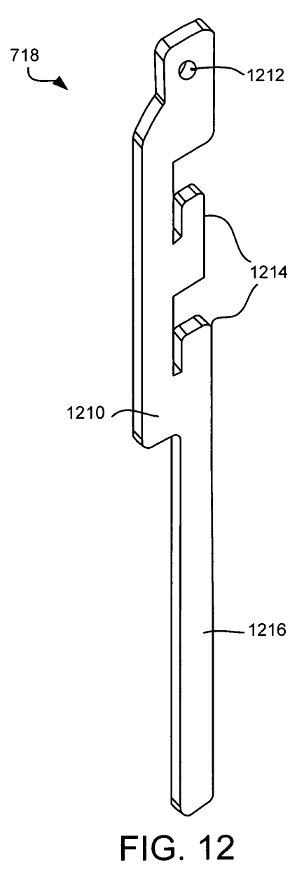

FIG. 12 shows details of the tilt bracket 718. The tilt bracket 718 comprises an elongate, relatively flat body 1210, a lower portion 1216 for engagement with the tilt arm 713, a hole 1212 disposed at the opposite end from the lower portion 1216 for engagement with the sliding arm 712, and hooks 1214 for engagement with a display attachment apparatus, such as the apparatus 300 (FIGS. 3A and 3B).

Referring again particularly to FIG. 7A, the sliding arm 712 engages the mounting bracket 710 in sliding engagement via a bolt 722 that runs through the sliding arm holes 918 and the mounting bracket slot 722. Spacers 724 may be provided to centrally situate the sliding arm flanges 912 on the bolt 722. While in one embodiment the apparatus 700 can be placed in a fixed position relative to the mounting surface without detents or arresting mechanisms, a locking mechanism 725 is provided adjacent the sliding arm 712 for additional position security and for fixing position during installation, etc. A set screw 725a engages the locking mechanism into the slot 820.

The tilt arm 713 consists of the major segment 714 and the minor segment 716, which alternatively may be viewed as two separate arms. The major segment 714 consists of the two sub-segments 714a, which are placed parallel to each other and operate in tandem. A bolt 726 running through the mounting bracket hole 818 and the sub-segment holes 1012 attaches the sub-segments 714a to the mounting bracket 710 in pivotal engagement. The sub-segments 714a may be centered on the bolt 726 with spacers or the like, if needed.

A bolt 728 runs through the sub-segment holes 1014 and the sliding arm holes 916, placing the major segment 714 and the sliding arm 712 in pivotal engagement.

A bolt 730 runs through the sliding arm holes 914 and the tilt bracket hole 1212 to place the sliding arm 712 and the tilt bracket 718 in pivotal engagement. Spacers 732 center the tilt bracket 718 between the sliding arm flanges 912.

A bolt 734 runs through the major segment holes 1014 and the minor segment slots 112, allowing the minor segment 716 to move somewhat relative to the major segment 714. A bolt 736 runs through the major segment angled slots 1018 and the minor segment holes 1114, also allowing for movement between the major and minor segments 714 and 716. The central portion 1116 of the minor segment abuts the tilt bracket 718 at its lower portion 1216.

The arrangement of the bolts 734 and 736 with the slots 1112 and 1018 and holes 1114 and 1016 fixes the major and minor segments 714 and 716 into one of two alternative tilting positions: untilted and tilted. FIG. 7A shows the apparatus 700 in an untilted position, wherein the major and minor segments 714 and 716 collectively act as a single straight arm 713. With the sliding arm 712 and the tilting arm 713 engaging the tilt bracket 718 at approximately the same horizontal degree, the tilt bracket 718, and thus the display 124 to which it is operatively attached, is positioned substantially vertically, i.e., untilted.

In the untilted position of FIG. 7A, the bolt 734 is disposed in the lower portion of the slot 1112, and the bolt 736 is disposed in the upper portion 1018a of the angled slot 1018. A biasing mechanism such as a spring (not shown) may be provided between the bolt 728 and the bolt 736 to urge the major and minor segments 714 and 716 into this arrangement, though the simple weight of the display 124 will, in some embodiments and at some angles, do the same thing by itself.

FIG. 7B shows the apparatus 700 in a tilted position, wherein the major and minor segments 714 and 716 have articulated relative to each other and the minor segment 716 has moved angularly downward, causing its central portion 1116 to move horizontally toward the mounting bracket 710. The weight of the display 124 pushes the lower portion 1216 of the tilt bracket 718 toward the central portion 1116, which in one embodiment slides along the lower portion 1216 in downward vertical movement caused by the angular motion. With the sliding arm 712 and the tilting arm 713 engaging the tilt bracket 718 at differing horizontal degrees, the tilt bracket 718, and thus the display 124 to which it is operatively attached, is positioned in a non-vertical, i.e., tilted, position.

In the tilted position of FIG. 7B, the bolt 734 is disposed in the upper portion of the slot 1112, and the bolt 736 is disposed in the rearward portion 1018b of the angled slot 1018, with the weight of the display 124 and/or any biasing mechanism provided urging the major and minor segments 714 and 716 into this arrangement.

To switch between the untilted and tilted positions of FIG. 7A and FIG. 7B, the weight of the display is relieved and the minor segment 716 moved into the desired position.

FIG. 7A shows the apparatus 700 in an extended translational position, i.e., away from the wall, accomplished by unlocking the locking mechanism 725, if necessary, and pulling the tilt bracket 718 away from the wall, causing the sliding arm 712 and the tilt arm 713 to pivot around the bolt 728. Said pivoting action causes the bolt 722 to rise in the slot 820 and the central portion 1116 of the minor segment 716 to rise as well, sliding up the lower portion 1216 of the tilt bracket 718 as the arms 712 and 713 become relatively more horizontally oriented.

FIG. 7B shows the apparatus 700 in a collapsed translational position, i.e., toward the wall, accomplished by unlocking the locking mechanism 725, if necessary, and pushing the tilt bracket 718 toward the wall, causing the sliding arm 712 and the tilt arm 713 to pivot around the bolt 728. Said pivoting action causes the bolt 722 to descend in the slot 820 and the central portion 1116 of the minor segment 716 to descend as well, sliding down the lower portion 1216 of the tilt bracket 718 as the arms 712 and 713 become relatively more vertically oriented.

Variations on aspects of the described embodiments will be apparent to those skilled in the art in light of this disclosure while remaining within the scope of the invention. Components of the described apparatuses may be combined with other components or separated into sub-components without departing from the scope of the invention.

While flat-panel displays are used in one embodiment of the invention, other devices suitable for mounting may also be used, such as a picture, painting, billboard, etc.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A display mounting apparatus, the apparatus comprising:
a first arm, the first arm having a proximal end and a distal end, the proximal end operatively attaching to a mounting surface, and the distal end operatively attaching to the display;
a second arm, the second arm having a proximal end and a distal end, the proximal end operatively attaching to the mounting surface, and the distal end operatively attaching to the display;
wherein the first arm and the second arm are disposed in approximately the same vertical plane, and wherein the first arm and the second arm cross each other at a crossing point, the crossing point disposed between the proximal end and the distal end of the first arm and between the proximal end and the distal end of the second arm.

2. The apparatus of claim 1, further comprising a mounting bracket attaching to the mounting surface, and wherein the proximal ends of the first and second arms attach to the mounting bracket.

3. The apparatus of claim 1, further comprising a display attachment assembly attaching to the display, and wherein the distal ends of the first and second arms attach to the display attachment assembly.

4. The apparatus of claim 1, wherein the crossing point is disposed at approximately the midpoint of the first arm and approximately the midpoint of the second arm.

5. The apparatus of claim 2, wherein the first arm and the second arm are movably attached at the crossing point, and wherein the proximal end of the second arm is disposed below the proximal end of the first arm, the proximal end of the second arm configured to attach at any of a plurality of points on the mounting bracket, whereby the display is enabled for movement toward or away from the mounting surface by moving the first and second arms relative to each other, thereby moving the distal ends of the first and second arms toward or away from the mounting surface.

6. The apparatus of claim 5, wherein the proximal end of the second arm slidably engages the mounting bracket.

7. The apparatus of claim 6, further comprising a locking mechanism configured to lock the proximal end of the second arm into position on the mounting bracket.

8. The apparatus of claim 1, wherein the first arm is configured to articulate at an articulation site disposed between the distal end of the first arm and the crossing point, the first arm thus comprising a major segment, the major segment disposed between the proximal end of the first arm and the articulation point, and a minor segment, the minor segment disposed between the articulation site and the distal end of the first arm.

9. The apparatus of claim 8, further comprising a positioning mechanism, the positioning mechanism configured to hold the major and minor segments in fixed relation to each other at any of a plurality of angles.

10. The apparatus of claim 9, wherein the positioning mechanism comprises a ratchet mechanism.

11. The apparatus of claim 8, further comprising an angled slot disposed on the major segment, a first protrusion disposed on the major segment, an elongated slot disposed on the minor segment, and a second protrusion disposed on the minor segment, wherein the second protrusion engages the angled slot and the first protrusion engages the elongated slot.

12. The apparatus of claim 11, further comprising a biasing mechanism configured to urge the second protrusion toward the crossing point.

13. The apparatus of claim 11, wherein the elongated slot has an upper portion and a lower portion, and the angled slot has an upper portion and a rearward portion, the major segment and the minor segment having a first angular position wherein the first protrusion is disposed in the upper portion of the elongated slot and the second protrusion is disposed in the rearward portion of the angled slot, the major segment and the minor segment having a second angular position wherein the first protrusion is disposed in the lower portion of the elongated slot and the second protrusion is disposed in the upper portion of the angled slot.

14. The apparatus of claim 11, further comprising a tilt bracket operatively attaching to the display, the tilt bracket further operatively attaching to the distal ends of the first and second arms, wherein the tilt bracket is configured to be positioned at any of a plurality of tilting orientations according to the angle between the major segment and the minor segment.

15. The apparatus of claim 3, wherein the display attachment assembly comprises a cross member operatively attaching to the distal ends of the first and second arms, the cross member configured for horizontal movement relative to the first and second arms, the display attachment assembly further comprising a vertical attachment member attached to the cross member at any of a plurality of points, the cross member configured for horizontal movement relative to the vertical attachment member, wherein the vertical attachment member attaches to the display at any of a plurality of vertical attachment points, whereby the display can be positioned vertically and horizontally at any of a plurality of positions.

16. The apparatus of claim 5, wherein the mounting bracket, the first arm, and the second arm collectively constitute a first mounting assembly, and further comprising a second mounting assembly of approximately identical construction to the first mounting assembly, the second mounting assembly attaching to the mounting surface and the display laterally from the first mounting assembly, and wherein the display is configured for panning by moving the distal ends of the arms of the first mounting assembly arms a different distance from the mounting surface than the distal ends of the arms of the second mounting assembly.

17. A display mounting apparatus comprising:
a mounting bracket attaching to a mounting surface;
a display bracket operatively attached to the display;
an X bracket having two arms and four ends, the first and second ends attaching to the mounting bracket, the third end attaching to the display bracket, and the fourth end abutting the display bracket, the X bracket being disposed in approximately a single vertical plane.

18. The apparatus of claim 17, wherein the second end of the X bracket attaches to the mounting bracket in sliding engagement, and wherein the arms of the X bracket are pivotally attached at the point where the arms cross each other, whereby the display bracket and display are configured to move closer to or farther from the mounting surface according to the degree to which the X bracket arms pivot relative to each other.

19. The apparatus of claim 17, wherein the fourth end of the X bracket is configured to move independently of the first, second, and third ends, thereby urging the display bracket and display into a tilted position.

20. A flat panel display mounting system, the system comprising:
a flat panel display;
a tilt bracket having upper and lower portions, the tilt bracket operatively attaching to the flat panel display;
a mounting bracket adapted for mounting on a wall or other mounting surface;
a first arm having proximal and distal ends, the proximal end attaching to the mounting bracket in sliding engagement, and the distal end attaching to the upper portion of the tilt bracket;
a second arm having proximal and distal ends, the proximal end attaching to the mounting bracket, the second arm pivotally engaging the first arm at a crossing point such that the first and second arms are configured to be positioned in any of a plurality of angles relative to each other;
whereby the distal ends of the first and second arms are configured to move closer to or farther away from the mounting surface according to the angle between the first and second arms and the point at which the proximal end of the first arm attaches to the mounting bracket;
a third arm having proximal and distal ends, the distal end attaching to the lower portion of the tilt bracket, and the proximal end attaching to the distal end of the second arm, the first, second, and third arms being disposed in approximately the same vertical plane; and
an articulation mechanism configured to articulate the second arm and the third arm in a plurality of angles, whereby the tilt bracket and the display are tilted according to the angle of articulation between the second and third arms.

21. The flat-panel display mounting system of claim 20, wherein the mounting bracket, the tilt bracket, the first, second, and third arms, and the articulation mechanism collectively constitute a first mounting assembly, and further comprising a second mounting assembly of similar construction to the first mounting assembly, the second mounting assembly attaching to the mounting surface laterally from the first mounting assembly, enabling the display to be panned, tilted, and translationally moved toward or away from the mounting surface.

22. The flat-panel display mounting system of claim 21, further comprising a display attachment assembly, the display attachment assembly comprising a cross member operatively attaching to the tilt brackets of the first and second mounting assemblies, the cross member configured for horizontal movement relative to the tilt brackets, a vertical attachment member attaching to the cross member at any of a plurality of horizontal attachment points and attaching to the display at any of a plurality of vertical attachment points, thereby enabling the display to be placed in any of a plurality of vertical and horizontal positions.
